(19) United States
(12) Patent Application Publication
(10) Pub. No.: US 2026/0032744 A1
(43) Pub. Date: Jan. 29, 2026

(54) COMMUNICATION METHODS AND TERMINAL DEVICES

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN)

(21) Appl. No.: 19/342,902

(22) Filed: Sep. 29, 2025

Related U.S. Application Data
(63) Continuation of application No. PCT/CN2023/086627, filed on Apr. 6, 2023.

(51) Int. Cl. H04W 76/14

(52) U.S. Cl. CPC H04W 76/14

(57) ABSTRACT

A communication method includes: a first terminal device transmitting first indication information, where the first indication information being used to indicate connection information, and the connection information includes: whether a first-type terminal device and/or a second-type terminal device are capable of establishing connection with the first terminal device.

### CROSS-REFERENCE TO RELATED APPLICATION

This application is a Continuation application of International Application No. PCT/CN2023/086627 filed on Apr. 6, 2023, which is incorporated herein by reference in its entirety.

### TECHNICAL FIELD

Embodiments of the present disclosure relate to the field of communication technology, and to a communication method and a terminal device.

### RELATED ART

With the development of technology, terminal IoT use cases such as industrial wireless sensors, video surveillance and wearable devices have put forward new requirements for terminal devices. For example, for terminal devices in these scenarios, new requirements such as reduced complexity and cost, smaller size and lower energy consumption have been put forward. To meet the above requirements, reduced capability (RedCap) terminal devices have been introduced into some communication systems (such as R17 NR system).

In communication systems based on a Uu interface, an access control mechanism for reduced capability devices has been introduced to control whether the reduced capability devices can access a certain frequency band.

### SUMMARY

The present disclosure provides a communication method and a terminal device.

In a first aspect, a communication method is provided and includes: transmitting, by a first terminal device, first indication information; where the first indication information is used to indicate connection information, and the connection information includes: whether a first-type terminal device and/or a second-type terminal device are capable of establishing a connection with the first terminal device.

In a second aspect, a communication method is provided and includes: receiving, by a second terminal device, first indication information transmitted by a first terminal device; where the first indication information is used to indicate connection information, and the connection information includes: whether a first-type terminal device and/or a second-type terminal device are capable of establishing a connection with the first terminal device.

In a third aspect, a communication method is provided and includes: receiving, by a first terminal device, second indication information transmitted by a second terminal device; where the second indication information is used to indicate terminal information, and the terminal information includes: the second terminal device being a first-type terminal device or a second-type terminal device.

In a fourth aspect, a communication method is provided and includes: transmitting, by a second terminal device, second indication information to a first terminal device; where the second indication information is used to indicate terminal information, and the terminal information includes: the second terminal device being a first-type terminal device or a second-type terminal device.

In a fifth aspect, a terminal device is provided, where the terminal device is a first terminal device and includes: a first transmitting unit, configured to transmit first indication information; where the first indication information is used to indicate connection information, and the connection information includes: whether a first-type terminal device and/or a second-type terminal device are capable of establishing a connection with the first terminal device.

In a sixth aspect, a terminal device is provided, where the terminal device is a second terminal device and includes: a first receiving unit, configured to receive first indication information transmitted by a first terminal device; where the first indication information is used to indicate connection information, and the connection information includes: whether a first-type terminal device and/or a second-type terminal device are capable of establishing a connection with the first terminal device.

In a seventh aspect, a terminal device is provided, where the terminal device is a first terminal device and includes: a second receiving unit, configured to receive second indication information transmitted by a second terminal device; where the second indication information is used to indicate terminal information, and the terminal information includes: the second terminal device being a first-type terminal device or a second-type terminal device.

In an eighth aspect, a terminal device is provided, where the terminal device is a second terminal device and includes: a second transmitting unit, configured to transmit second indication information to a first terminal device; where the second indication information is used to indicate terminal information, and the terminal information includes: the second terminal device being a first-type terminal device or a second-type terminal device.

In a ninth aspect, a terminal device is provided and includes: a processor and a memory; where the memory is configured to store one or more computer programs, and the processor is configured to call the computer programs in the memory, to enable the terminal device to perform part or all of the steps in the methods of the various aspects described above.

In a tenth aspect, the embodiments of the present disclosure provide a communication system, and the system includes the above terminal devices. In another possible design, the system may also include other devices that interact with the terminal device in the solutions provided in the embodiments of the present disclosure.

In an eleventh aspect, the embodiments of the present disclosure provide a non-transitory computer-readable storage medium, where the non-transitory computer-readable storage medium has a computer program stored thereon, and the computer program enables the terminal device to perform part or all of the steps in the methods of the various aspects described above.

In the twelfth aspect, the embodiments of the present disclosure provide a computer program product, where the computer program product includes a non-transitory non-transitory computer-readable storage medium storing a computer program, and the computer program is operable to enable a terminal device to perform part or all of the steps in the methods of the various aspects described above. In some implementations, the computer program product may be a software installation package.

In a thirteenth aspect, the embodiments of the present disclosure provide a chip, and the chip includes a memory and a processor; where the processor may call a computer program stored in the memory and run the computer program, to implement part or all of the steps in the methods of the various aspects described above.

### BRIEF DESCRIPTION OF THE DRAWINGS

FIG. 1 is a schematic diagram of a wireless communication system to which an embodiment of the present disclosure is applied.

FIG. 2 is a schematic diagram of another wireless communication system to which an embodiment of the present disclosure is applied'.

FIG. 3 is a schematic flowchart of a communication method provided in an embodiment of the present disclosure.

FIG. 4 is a schematic flowchart of another communication method provided in an embodiment of the present disclosure.

FIG. 5 is a schematic flowchart of a communication method provided in Embodiment I of the present disclosure.

FIG. 6 is a schematic flowchart of a communication method provided in Embodiment II of the present disclosure.

FIG. 7 is a schematic flowchart of a communication method provided in Embodiment III of the present disclosure.

FIG. 8 is a schematic structural diagram of a terminal device provided in an embodiment of the present disclosure.

FIG. 9 is a schematic structural diagram of another terminal device provided in an embodiment of the present disclosure.

FIG. 10 is a schematic structural diagram of another terminal device provided in an embodiment of the present disclosure.

FIG. 11 is a schematic structural diagram of another terminal device provided in an embodiment of the present disclosure.

FIG. 12 is a schematic structural diagram of an apparatus for communication provided in an embodiment of the present disclosure.

### DETAILED DESCRIPTION

Technical solutions in the present disclosure will be described in combination with accompany drawings.

### Communication System

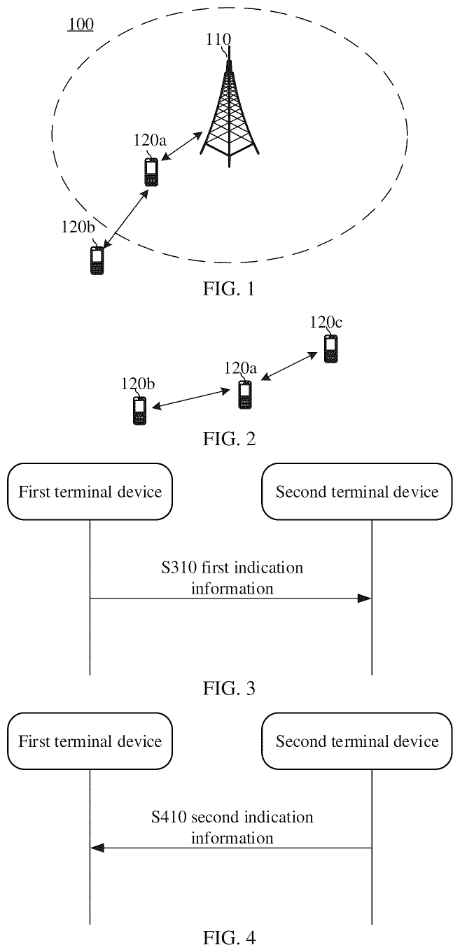

FIG. 1 is a wireless communication system 100 to which an embodiment of the present disclosure is applied. The wireless communication system 100 may include a network device 110 and a terminal device 120. The network device 110 may be a device that communicates with the terminal device 120. The network device 110 may provide network coverage for a specific geographical area, and may communicate with a terminal device 120 (e.g., the terminal device 120a in FIG. 1) located within the coverage area. The terminal device 120 may access a network (such as a wireless network) through the network device 110. Optionally, the wireless communication system 100 may further include other network entities such as a network controller and a mobility management entity, and the embodiments of the present disclosure are not limited thereto.

It is to be understood that the technical solutions of the embodiments of the present disclosure may be applied to various communication systems, such as, a 5th generation (5G) system or a new radio (NR) system, a long term evolution (LTE) system, an LTE frequency division duplex (FDD) system and an LTE time division duplex (TDD). The technical solutions provided in the present disclosure may also be applied to future communication systems, such as a 6th generation mobile communication system and a satellite communication system.

Where 5G researched by the 3rd generation partnership project (3GPP) aims to meet people's pursuit of speed, latency, high-speed mobility and energy efficiency, and adapt to diversity and complexity of services in future life. The main application scenarios of 5G include: enhanced mobile broadband (eMBB), ultra-reliable & low latency communications (URLLC), and massive machine type communication (mMTC).

The terminal device in the embodiments of the present disclosure may also be referred to as a user equipment (UE), a access terminal, a user unit, a user station, a mobile platform, a mobile station (MS), a mobile terminal (MT), a remote station, a remote terminal, a mobile device, a user terminal, a terminal, a wireless communication device, a user agent or a user apparatus. The terminal device in the embodiments of the present disclosure may refer to a device that provides voice and/or data connectivity to users and may be used to connect people, objects and machines, such as a handheld device or a vehicle-mounted device with a wireless connection function. The terminal device in the embodiments of the present disclosure may be a mobile phone, a pad, a laptop computer, a personal digital assistant, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. Optionally, the terminal device may be used to act as a base station. For example, the terminal device may act as a scheduling entity that provides sidelink signals between terminal devices in V2X or D2D or the like. For example, a cellular phone and a car communicate with each other using sidelink signals. The cellular phone and a smart home device communicate with each other without relaying communication signals through a base station.

The network device in the embodiments of the present disclosure may be a device that is used to communicate with the terminal device, and the network device may also be referred to as an access network device or a wireless access network device, for example, the network device may be a base station. The network device in the embodiments of the present disclosure may refer to a radio access network (RAN) node (or device) that connects the terminal device to the wireless network. The base station may broadly cover various names among, or be replaced with, the following names, such as: a NodeB, an evolved NodeB (eNB), a next generation NodeB (gNB), a relay station, an access point, a transmitting and receiving point (TRP), a transmitting point (TP), a master eNB (MeNB), a secondary eNB (SeNB), a multi-standard wireless node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node or analogues, or a combination thereof.

In some communication systems (such as the NR system), radio resource control (RRC) states may include a RRC idle state (RRC_IDLE), a RRC connected state (RRC_CONNECTED), and a RRC inactive state (RRC_INACTIVE) or the like.

Under the RRC_IDLE, there is no RRC connection between the terminal device and the network device. The mobility of the terminal device is mainly reflected in terminal device-based cell selection/reselection. Under the RRC_IDLE, a paging process of the network device for the terminal device is initiated by a core network (CN), and a paging area is configured by the CN. In addition, under the RRC_IDLE, there is no access stratum (AS) context of the terminal device in the network device.

Under the RRC_CONNECTED, there is an RRC connection between the terminal device and the network device. Both the network device and the terminal device store the AS context of the terminal device. Under the RRC_CONNECTED, a location of a terminal device that the network device can know is a cell-level location. Under the RRC_CONNECTED, unicast data may be transmitted between the terminal device and the network device, and the mobility of the terminal device is managed and controlled by the network device.

The RRC_INACTIVE is a new RRC state defined in the NR system. Under the RRC_INACTIVE, there is a connection between CN and NR. The AS context of the terminal device is stored in a certain network device. The paging process of the network device for the terminal device may be triggered by a RAN, and a RAN-based paging area may be managed by the RAN. In addition, under the RRC_INACTIVE, the location of the terminal device that the network device can know is an RAN-based paging area-level location, and the mobility of the terminal device is mainly reflected in terminal device-based cell selection/reselection.

Communication between the terminal devices may be performed through a sidelink (SL). The sidelink communication may also be referred to as a proximity services (ProSe) communication, an unilateral communication, a side-link communication, and a device to device (D2D) communication. As illustrated in FIG. 1, the terminal device 120a and the terminal device 120b may communicate with each other through the sidelink.

### Relay Technology

The relay technology is introduced into some communication systems (such as the NR systems). The relay technology supports that a connection between communication devices is established through a relay terminal device (relay UE) or a relay node. For example, a relay between the terminal device and the network device (UE-to-network relay) may support a remote terminal device (remote ULE) to establish a connection with the network device through the relay terminal device. The remote terminal device may be a terminal device located outside the coverage range of the network device (hereinafter, the coverage range of the network device is simply referred to as the network coverage range). Therefore, the relay technology between the terminal device and the network device can expand the network coverage range.

Taking FIG. 1 as an example, some terminal devices (such as the terminal device 120a in FIG. 1) are located within the coverage of the network device 110, while some terminal devices (such as the terminal device 120b in FIG. 1) are located outside the network coverage range. The terminal device 120b located outside the network coverage range may be the remote terminal device, and the terminal device 120a located within the network coverage range may serve as a relay terminal device of the remote terminal device 120b, so that a connection between the remote terminal device 120b and the network is established.

It is to be noted that FIG. 1 illustrates a scenario in which the remote terminal device is connected to the network through a relay terminal device, and the embodiments of the present disclosure are not limited thereto. The remote terminal device may also establish the connection with the network through multiple relay terminal devices.

Based on the relay technology, a relay between the terminal device and the terminal device (UE-to-UE relay) may also be realized. For example, the remote terminal device may establish a connection with another terminal device through the relay terminal device. Taking FIG. 2 as an example, the terminal device 120a may be a relay terminal device. Both the terminal device 120b and the terminal device 120c may establish a connection with the relay terminal device 120a, so that the terminal device 120b communicates with the terminal device 120c through the relay terminal device 120a.

It is to be noted that FIG. 2 illustrates a scenario in which the remote terminal device is connected to other terminal devices through a relay terminal device, and the embodiments of the present disclosure are not limited thereto. The remote terminal device may also establish the connections with other terminal devices through multiple relay terminal devices.

### Reduced Capability Terminal Device

In addition to application scenarios such as eMBB and URLLC supported by some communication systems (such as R15/R16 NR systems), terminal IoT use cases such as industrial wireless sensors, video surveillance and wearable devices have put forward new requirements for terminal devices. For example, for terminal devices in these scenarios, new requirements such as reduced complexity and cost, smaller size and lower energy consumption have been put forward. To meet the above requirements, the reduced capability terminal devices (hereinafter simply referred to as reduced capability devices) have been introduced into some communication systems (such as R17 NR system).

At present, the reduced capability devices are mainly used in three scenarios. These three scenarios are: the industrial wireless sensors, the video surveillance, and the wearable devices (wearables), which are introduced below separately.

Compared with URLLC, the industrial wireless sensors involved in the reduced capability devices have relatively low requirements for latency and reliability. Meanwhile, the cost and power consumption of such devices are lower than those of URLLC and eMBB. The main requirements and characteristics of terminal devices in such scenarios include: communication reliability being 99.99%, end-to-end latency being less than 100 ms (i.e., <100 ms), a reference data rate being less than 2 Mbps and mainly focused on uplink services, devices being stationary and battery life being required up to several years. For a scenario involving safety-related sensors, the latency requirement is even lower, ranging from 5 to 10 ms.

The video surveillance is mainly used for video monitoring in smart cities, industrial factories or the like. Data collection and processing may be realized in the smart cities through the video surveillance, so as to realize more effective monitoring and control of urban resources and provide more effective services to urban residents. Video surveillance scenarios mainly focus on uplink services, and other main requirements include: a reference rate of ordinary resolution video ranging from 2 to 4 Mbps (i.e., 2˜4 Mbps), latency being less than 500 ms and communication reliability ranging from 99% to 99.9% (i.e., 99%˜99.9%). In particular, for high-definition video, the rate requirement may range from 7.5 to 25 Mbps (i.e., 7.5˜25 Mbps).

The wearable devices may include a smart watch, a smart bracelet, an electronic health device, some medical monitoring devices or the like. Small size is a common feature of these devices. The key indicator requirements for terminal devices in such scenarios include: downlink and uplink reference rates ranging from 5 to 50 Mbps (i.e., 5˜50 Mbps) and ranging from 2 to 5 Mbps (i.e., 2˜5 Mbps), respectively; downlink and uplink peak rates being 150 Mbps and 50 Mbps, respectively. In addition, the terminal devices in such scenarios also require the battery to work for several days or even 1 to 2 weeks.

### Technical Solutions for Reduced Capability Terminals to Reduce Complexity and Cost

Compared with the reduced capability devices, terminal devices in the application scenarios such as eMBB and URLLC supported by some communication systems (such as R15/R16 NR systems) have higher complexity to meet the requirements such as rate, efficiency or network capacity. For example, for eMBB applications, in order to provide higher peak rate, frequency efficiency and network capacity, the 3GPP standard puts forward higher requirements for eMBB terminal devices. The requirements may include, for example, that the eMBB terminal devices, for a NR frequency range 1 (FR1) band, need to support functions and performance indicators such as 100 MHz carrier bandwidth, 4 receive links (i.e. 4 Rx), a 4 stream multiple input multiple output (MIMO) transmission, a 256QAM modulation and a peak rate above 1 Gbps. It can be seen that the above requirements make processing capabilities of radio frequency devices and baseband chips of the terminals meet higher requirements, resulting in higher complexity and cost of these terminal devices.

For the reduced capability terminal devices, some communication standards have begun to discuss technical solutions on how to reduce the complexity and cost. For example, in the R17 RedCap SI phase, the requirements for reducing the following nine terminal capabilities are mainly studied to reduce the complexity and cost.

### (1) Reducing Maximum Bandwidth of Terminal Device

In order to enable the reduced capability device and non-reduced capability (non-RedCap) terminal device to share the same synchronization block (synchronization signal/PBCH block, SS/PBCH block), a control resource set 0 (CORESET0) and system information broadcast 1 (SIB1), the 3GPP has agreed through discussion that the maximum bandwidth of the reduced capability device is reduced from 100 MHz to 20 MHz in the FR1 frequency band. Meanwhile, the maximum bandwidth of the reduced capability device is reduced to 100 MHz in the FR2 frequency band.

### (2) Reducing the Number of Receiving (Rx) Antennas of Terminal Device

On frequency bands where a normal NR terminal is required to support at least 2 receiving antenna ports, the minimum number of receiving antennas supported by the reduced capability device is 1. On these frequency bands, the number of receiving antennas of the reduced capability device may also be 2.

On frequency bands where a normal NR UE is required to support a minimum of 4 receiving antenna ports, the minimum number of receiving antennas supported by the reduced capability device is 1. On these frequency bands, the number of receiving antennas of the reduced capability device may also be 2.

### (3) Reducing the Number of MIMO Layers of Terminal Device

For the reduced capability device having a number of receiving antennas of 1, one-layer downlink (DL) MIMO may be supported. For the reduced capability device having a number of receiving antennas of 2, 2-layers DL MIMO may be supported.

### (4) Reducing Highest Modulation Order

Using a lower modulation order may reduce the requirements for processing capabilities of radio frequency devices and baseband chips. For the relaxation of the highest modulation order, the following options are mainly studied.

For uplink (UL), in the FR1 frequency band, the highest modulation order is reduced from 64QAM to 16QAM; and in the FR2 frequency band, the highest modulation order is reduced from 64QAM to 16QAM.

For DL, in the FR1 frequency band, the highest modulation order is reduced from 256QAM to 64QAM; and in the FR2 frequency band, the highest modulation order is reduced from 64QAM to 16QAM.

### (5) Adopting Half Duplex Frequency Division Duplex (HD-FDD)

Compared with full-duplex frequency division duplex (FDD), by adopting a HD-FDD mode, the reduced capability device may perform transmission and reception on different frequencies at different times; and a cheaper transmit-receive antenna switch and a low-pass filter may be used in implementation instead of a more expensive duplexer.

Some communication systems (e.g. LTE) define two HD-FDD modes for the terminal device. The two modes are Type A and Type B. Considering that HD-FDD Type B is too complex, 3GPP RAN decided through discussion that Rel-17 FDD reduced capability device supports the HD-FDD Type A operation.

### (6) Relaxing Processing Time of Terminal Device

The terminal device requires a certain processing time between receiving a physical downlink shared channel (PDSCH) and transmitting an uplink hybrid automatic repeat request (HARQ) feedback, and between receiving a physical downlink control channel (PDCCH) indicating uplink scheduling and transmitting a physical uplink shared channel (PUSCH). The processing time is shorter as the processing capacity of the hardware of the terminal device is higher. Therefore, the requirement for the processing time of the terminal device is relaxed, that is, allowing a longer processing time, which may relax the requirement for the processing module of the receiver, thereby reducing the cost of the terminal device.

(7) Reducing the Maximum Number of Data Resource Bearers (DRBs) that Terminal is Mandatory to Support

In Rel-15/Rel-16, the maximum number of the DRBs supported by the terminal device is 8. Moreover, this capability is a mandatory capability of the terminal device. Judging from the three main application scenarios currently supported by the reduced capability device, the terminal device generally does not have multiple parallel services at the same time. In addition, the number of DRBs will directly affect the buffer size and memory size of the terminal device. Therefore, it is considerable to reduce the cost of the terminal device by reducing the maximum number of DRBs supported by the terminal device.

### (8) Reducing Layer 2 Buffer Size

The layer 2 buffer size mainly depends on the number of uplink and downlink peaks and a radio link control (RLC) round trip time (RTT). Compared with the Rel-15/Rel-16 normal NR terminal device, the reduced capability device is required to support a lower peak rate, and the layer 2 buffer size may be reduced accordingly.

### (9) Reducing Packet Data Convergence Protocol (PDCP)/RLC Sequence Number (SN) Length

The RLC/PDCP SN length is related to the length of the sliding window that the RLC/PDCP layer needs to support. In the Rel-15/Rel-16, for PDCP and RLC AM modes, the SN length of 18 bits must be supported. If the buffer size of the reduced capability device is reduced compared to that of Rel-15/Rel-16, it is not necessary for the reduced capability device to force to support the RLC/PDCP SN length of 18 bits.

### Access Control Mechanism

In communication systems based on a Uu interface, an access control mechanism for the reduced capability devices has been introduced to control whether the reduced capability devices can access a certain frequency band. For example, the redCapAccessAllowed-r17 field is added to indicate whether the reduced capability devices are allowed to access the frequency. The relevant information of the redCapAccessAllowed-r17 field is as follows:

InterFreqCarrierFreqInfo-v1700 ::= SEQUENCE {

| | |
|---|---|
| interFreqNeighHSDN-CellList-r17 | InterFreqNeighHSDN-CellList-r17 |

| | |
|---|---|
| OPTIONAL, | -- Need R |

| | |
|---|---|
| highSpeedMeasInterFreq-r17 | ENUMERATED {true} |

| | |
|---|---|
| OPTIONAL, | -- Need R |

| | |
|---|---|
| redCapAccessAllowed-r17 | ENUMERATED {true} |

| | |
|---|---|
| OPTIONAL, | -- Need R |

| | |
|---|---|
| ssb-PositionQCL-Common-r17 | SSB-PositionQCL-Relation-r17 |

| | |
|---|---|
| OPTIONAL, | -- Cond SharedSpectrum |

| | |
|---|---|
| interFreqNeighCellList-v1710 | InterFreqNeighCellList-v1710 |

| | |
|---|---|
| OPTIONAL | -- Cond SharedSpectrum2 |

}

For a sidelink communication system, the present disclosure also proposes technical solutions of access control. The technical solutions proposed in the present disclosure are described in detail below in conjunction with FIG. 3 and FIG. 4.

FIG. 3 is a schematic flowchart of a communication method provided in an embodiment of the present disclosure. The method illustrated in FIG. 3 may be implemented by a first terminal device and a second terminal device. The first terminal device may communicate with the second terminal device through the sidelink. The method illustrated in FIG. 3 may include step S310.

In step S310: the first terminal device transmits first indication information. Correspondingly, the second terminal device receives the first indication information.

The first indication information may be used to indicate connection information. The connection information may include: whether a first-type terminal device and/or a second-type terminal device are capable of establishing a connection with the first terminal device. It is to be understood that, through the first indication information, the first terminal device may inform other terminal devices which type of terminal device is capable of establishing a connection with the first terminal device and which type of terminal device is incapable of establishing a connection with the first terminal device. That is, different pieces of connection information may correspond to different access control modes.

It is to be noted that establishing a connection may refer to establishing a connection of a sidelink. When the first terminal device establishes a connection with the second terminal device, the first terminal device may perform sidelink communication with the second terminal device. In some embodiments, establishing a connection may also be referred to as accessing.

As can be seen from the above, based on the transmitted first indication information, the first terminal device is capable of controlling the connection establishment between the first-type terminal device or the second-type terminal device and the first terminal device. That is, not any terminal is capable of establishing a connection with the first terminal device, but only a terminal type that is allowed to establish a connection by the first terminal device is capable of establishing a connection with the first terminal device. In other words, based on the present disclosure, an access control in the sidelink communication system may be realized. That is, the transmission of the first indication information may belong to the access control process.

In some embodiments, the first-type terminal device may be a reduced capability terminal device. In some embodiments, the reduced capability terminal device may be a terminal device applied to the terminal Internet of Things described above. For example, the reduced capability terminal device may be a terminal device applied to one or more of the following scenarios described above: industrial wireless sensors, video surveillance, and wearable devices. In some embodiments, the reduced capability terminal device may be a terminal device that meets the requirement of reducing terminal capability. For example, the content of the requirement of reducing terminal capability may refer to one or more of nine items described above.

In some embodiments, the second-type terminal device may be a non-reduced capability terminal device. Each terminal device that does not meet the requirement of the reduced capability terminal device may be referred to as the non-reduced capability terminal device. For example, the non-reduced capability terminal device may be a terminal device in an application scenario that supports eMBB, URLLC or the like.

It is to be noted that the reduced capability terminal device is just a name for such type of terminal devices with lower capability. This disclosure does not limit the name of such type of terminal devices. In some embodiments, the reduced capability terminal device may also be referred to as a low-complexity terminal device, a low-power consumption terminal device, or the like. Similarly, the non-reduced capability terminal device is a term for a terminal device with higher capability relative to the reduced capability terminal device. The present disclosure does not limit the name of such type of terminal devices. In some embodiments, the non-reduced capability terminal device may also be referred to as the ordinary terminal device, or the like.

The connection information may also be related to other capability information. For example, the other capability information may include one or more pieces of the following information related to the capability of the terminal device: a scenario, a number of receiving antennas, a number of transmitting antennas, a bandwidth, a frequency band or a reduced capability terminal type. For example, the connection information may also include one or more pieces of the following information: whether a terminal device under a first scenario is capable of establishing a connection with the first terminal device; whether a terminal device supporting a first number of receiving antennas is capable of establishing a connection with the first terminal device; whether a terminal device supporting a first number of transmitting antennas is capable of establishing a connection with the first terminal device; whether a terminal device supporting a first bandwidth is capable of establishing a connection with the first terminal device; or whether a terminal device in a first frequency band is capable of establishing a connection with the first terminal device. The content of other capability information is described below.

In some embodiments, the connection information may be related to the scenarios. The scenarios may include scenarios to which the reduced capability device is applied. For example, the scenarios to which the reduced capability device is applied may include one or more of: the industrial wireless sensors, the video surveillance devices or the wearable devices.

For example, the connection information may include: whether the terminal device under the first scenario is capable of establishing the connection with the first terminal device. That is, the first indication information may indicate whether the terminal device under the first scenario is capable of establishing the connection with the first terminal device. The first scenario may be a scenario to which the reduced capability device is applied.

For another example, the connection information may include one or more connection scenarios, and the terminal device(s) under the one or more connection scenarios is (are) capable of establishing the connection with the first terminal device. That is, the first indication information may indicate under which scenario(s) a terminal device is capable of establishing the connection with the first terminal device.

For another example, the connection information may include one or more prohibited connection scenarios, and the terminal devices under the one or more prohibited connection scenarios is (are) incapable of establishing the connection with the first terminal device. That is, the first indication information may indicate under which scenario(s) a terminal device is incapable of establishing the connection with the first terminal device.

It is to be noted that part or all of the one or more connection scenarios may be the scenarios to which the reduced capability device is applied. Part or all of the one or more prohibited prohibition scenarios may be the scenarios to which the reduced capability device is applied.

In some embodiments, the connection information may be related to the number of receiving antennas. For example, the number of receiving antennas may be the number of receiving antennas supported by the terminal device. For example, the number of antennas supported by the terminal device may include the minimum number of receiving antennas supported by the terminal device, the maximum number of receiving antennas supported by the terminal device, or the like.

For example, the connection information may include: whether the terminal device supporting the first number of receiving antennas is capable of establishing the connection with the first terminal device. That is, the first indication information may indicate whether the terminal device supporting the first number of receiving antennas is capable of establishing the connection with the first terminal device. For example, the first number of receiving antennas may be the minimum number of antennas or the maximum number of antennas supported by the terminal device.

For another example, the connection information may include one or more numbers of connection receiving antennas, and the terminal device supporting at least or at most the one or more numbers of connection receiving antennas is capable of establishing a connection with the first terminal device. That is, the first indication information may indicate that the terminal device supporting at least or at most a certain number of receiving antennas is capable of establishing a connection with the first terminal device.

For another example, the connection information may include one or more numbers of prohibited connection receiving antennas, and the terminal device supporting at least or at most the one or more numbers of prohibited connection receiving antennas is incapable of establishing a connection with the first terminal device. That is, the first indication information may indicate that the terminal device supporting at least or at most a certain number of receiving antennas is incapable of establishing a connection with the first terminal device.

In some embodiments, the connection information may be related to the number of transmitting antennas. For example, the number of transmitting antennas may be the number of transmitting antennas supported by the terminal device. For example, the number of antennas supported by the terminal device may include the minimum number of transmitting antennas supported by the terminal device, the maximum number of transmitting antennas supported by the terminal device, or the like.

For example, the connection information may include: whether the terminal device supporting the first number of transmitting antennas is capable of establishing the connection with the first terminal device. That is, the first indication information may indicate whether the terminal device supporting the first number of transmitting antennas is capable of establishing the connection with the first terminal device. For example, the first number of transmitting antennas may be the minimum number of antennas or the maximum number of antennas supported by the terminal device.

For another example, the connection information may include one or more numbers of connection transmitting antennas, and the terminal device supporting at least or at most the one or more numbers of connection transmitting antennas is capable of establishing a connection with the first terminal device. That is, the first indication information may indicate that the terminal device supporting at least or at most a certain number of transmitting antennas is capable of establishing a connection with the first terminal device.

For another example, the connection information may include one or more numbers of prohibited connection transmitting antennas, and the terminal device supporting at least or at most the one or more numbers of prohibited connection transmitting antennas is incapable of establishing a connection with the first terminal device. That is, the first indication information may indicate that the terminal device supporting at least or at most a certain number of transmitting antennas is incapable of establishing a connection with the first terminal device.

In some embodiments, the connection information may be related to the bandwidth. The bandwidth may include: the maximum bandwidth supported by the terminal device, or any bandwidth supported by the terminal device.

For example, the connection information may include: whether the terminal device supporting the first bandwidth is capable of establishing the connection with the first terminal device. That is, the first indication information may indicate whether the terminal device supporting the first bandwidth is capable of establishing the connection with the first terminal device. The first bandwidth may be any bandwidth supported by the terminal device, or the maximum bandwidth supported by the terminal device.

For another example, the connection information may include one or more connection bandwidths, and the terminal device that maximally supports the one or more connection bandwidths is capable of establishing a connection with the first terminal device. That is, the first indication information may indicate which terminal device that maximally supports which bandwidth(s) is capable of establishing a connection with the first terminal device.

For another example, the connection information may include one or more prohibited connection bandwidths, and the terminal device that maximally supports the one or more prohibited connection bandwidths is incapable of establishing a connection with the first terminal device. That is, the first indication information may indicate which terminal device that maximally supports which bandwidth(s) is incapable of establishing a connection with the first terminal device.

In some embodiments, the connection information may be related to the frequency band. For example, the frequency band may include the type of the frequency band supported by the terminal device. For example, the type of the frequency band may include the FR1 frequency band or the FR2 frequency band.

For example, the connection information may include: whether the terminal device supporting the first frequency band is capable of establishing the connection with the first terminal device. That is, the first indication information may indicate whether the terminal device supporting the first frequency band is capable of establishing the connection with the first terminal device. The first frequency band may be the FR1 frequency band or the FR2 frequency band.

For another example, the connection information may include one or more connection frequency bands. If the frequency band supported by the terminal device belongs to the one or more connection frequency bands, the terminal device is capable of establishing a connection with the first terminal device. That is, the first indication information may indicate which terminal device supporting which frequency band(s) is capable of establishing a connection with the first terminal device.

For another example, the connection information may include one or more prohibited connection frequency bands. If the frequency band supported by the terminal device belongs to the one or more prohibited connection frequency bands, the terminal device is incapable of establishing a connection with the first terminal device. That is, the first indication information may indicate which terminal device supporting which frequency band(s) is incapable of establishing the connection with the first terminal device.

In some embodiments, the connection information may be related to the reduced capability terminal type. The reduced capability terminal may be subdivided into different reduced capability terminal types. For example, the reduced capability terminal type may be divided into high-end and low-end. The capabilities of the high-end reduced capability device may be slightly higher than those of the low-end reduced capability device. The present disclosure does not limit the method for distinguishing or determining the reduced capability terminal type. For example, based on one or more of the nine items of the terminal capabilities described above, the reduced capability terminal type to which the terminal device belongs may be determined. Alternatively, the reduced capability terminal type may be divided into the FR1 type and the FR2 type. That is, the reduced capability device that supports the FR1 frequency band belongs to the FR1 type, and the reduced capability device that supports the FR2 frequency band belongs to the FR2 type.

For example, the connection information may include: whether a terminal device of a first reduced capability terminal type is capable of establishing a connection with the first terminal device. That is, the first indication information may indicate whether the terminal device of the first reduced capability terminal type is capable of establishing the connection with the first terminal device. For example, the first reduced capability terminal type may be high-end or low-end.

For another example, the connection information may include one or more connection reduced capability terminal types. If the reduced capability terminal type of the terminal device belongs to the one or more connection reduced capability terminal types, the terminal device is capable of establishing a connection with the first terminal device. That is, the first indication information may indicate which terminal device(s) having which reduced capability terminal type(s) is (are) capable of establishing a connection with the first terminal device.

For another example, the connection information may include one or more prohibited connection reduced capability terminal types. If the reduced capability terminal type of the terminal device belongs to the one or more prohibited connection reduced capability terminal types, the terminal device is incapable of establishing a connection with the first terminal device. That is, the first indication information may indicate which terminal device(s) having which reduced capability terminal type(s) is (are) incapable of establishing a connection with the first terminal device.

It is to be noted that the connection information may also be related to other information. For example, the other information may include one or more pieces of the following information: a number of MIMO layers, a modulation order (e.g., the highest modulation order), a duplex mode, a processing time, a number of DRBs (e.g., the maximum number of DRBs that are mandatory to support). That is, the first indication information may indicate that the corresponding terminal device is capable of establishing a connection with the first terminal device under which condition(s) is (are) met by the other information. Alternatively, the first indication information may indicate whether a connection may be established with the first terminal device when the other information of the terminal device has a specific value. For indication manners, reference can be made to the above description related to the scenario, the bandwidth or the like, which will not be repeated here.

It is to be noted that the connection information is only the name for the above information, and the connection information may also be represented by other names. For example, in a case where the connection information includes information of a terminal device that is prohibited from connecting to the first terminal device, the connection information may also be referred to as non-connection information.

The present disclosure does not limit the indication manners of the connection information. For example, the first indication information may explicitly indicate the connection information, and/or the first indication information may implicitly indicate the connection information.

In some embodiments, if the first indication information explicitly indicates the connection information, the first indication information may include the connection information. That is, the first terminal device may directly transmit the value of the connection information to the second terminal device through the first indication information. For example, the first indication information may be included in one or more of the following signaling or channels: a discovery message, a PC5-signaling (PC5-S) message, a PC5-radio resource control (PC5-RRC) message, a media access control element (MAC CE), or a physical sidelink control channel (PSCCH).

In some embodiments, the first indication information may include a first parameter. The first parameter may be associated with the connection information. In other words, different connection information may correspond to different first parameters. That is, different connection information may be distinguished by the first parameter. As an implementation, different first parameters may be reserved for access control modes corresponding to different connection information, so as to distinguish different access control modes.

The first parameter may be related to the first terminal device, or the first parameter may include an existing attribute or identifier of the first terminal device. As an implementation, for example, the first parameter may be one or more of the following: a layer 2 ID, a relay service code (RSC), a service identifier (ID), or a physical layer parameter. For example, the physical layer parameter may include at least one of: a reference signal (RS) sequence or an RS cyclic shift.

The present disclosure does not limit the transmission manner of the first indication information. The following are some examples.

In some embodiments, the first terminal device may actively transmit the first indication information. For example, the first indication information may be transmitted by broadcasting. For another example, the first indication information may be transmitted periodically. As an implementation, the first indication information may be carried in a discovery announcement message to implement active transmission.

In some embodiments, in response to a first request, the first terminal device may transmit the first indication information. The first request may be used to request acquisition of the first indication information. That is, the first terminal device may transmit the first indication information to the second terminal device only when the second terminal device requests to obtain the first indication information. For example, the first request may be carried in a discovery solicitation message, and the first indication information may be carried in a discovery response message. Alternatively, the first request may be carried in a direct communication request (DCR), and the first indication information may be carried in a security mode command (SMC) or a direct communication accept (DCA) message.

After receiving the first indication information, the second terminal device may determine whether to establish a connection with the first terminal device. For example, the second terminal device may determine whether to transmit a connection establishment request to the first terminal device based on the first indication information. The connection establishment request may include, for example, a DCR.

FIG. 4 is a schematic flowchart of another communication method provided in an embodiment of the present disclosure. The method illustrated in FIG. 4 may be implemented by a first terminal device and a second terminal device. The first terminal device may communicate with the second terminal device through the sidelink. The method illustrated in FIG. 4 may include step S410.

In step S410: the first terminal device receives second indication information. Correspondingly, the second terminal device transmits the second indication information.

The second indication information may be used to indicate terminal information. The terminal information may be used to indicate information related to the capability of the second terminal device. That is, the terminal information may indicate various capability indicators or requirements that the second terminal device is capable of supporting. For example, the terminal information may include: the second terminal device being a first-type terminal device or a second-type terminal device. The first-type terminal device and the second-type terminal device have been described in detail above and will not be repeated here.

The first terminal device may obtain the terminal information of the second terminal device through the second indication information. That is, the first terminal device may determine whether the second terminal device is the first-type terminal device or the second-type terminal device through the second indication information. Based on the received second indication information, the first terminal device may control the first-type terminal device or the second-type terminal device to establish a connection with the first terminal device, so as to perform access control on the second terminal device. That is, whether the second terminal device is capable of establishing a connection with the first terminal device is determined based on the second indication information. The second terminal device is capable of establishing the connection with the first terminal device only when the terminal information indicated by the second indication information meets a certain condition, so as to achieve the access control.

As an implementation, the terminal information may also be related to other capability information of the second terminal device. The other capability information may include one or more pieces of the following information related to the capability of the terminal device: a scenario, a number of receiving antennas, a number of transmitting antennas, a bandwidth, a frequency band or a reduced capability terminal type. For detailed description of the above other capability information, reference can be made to the above description of other capability information related to the connection information, which will not be repeated here. In some embodiments, the terminal information may further include one or more pieces of the following information: a scenario of the second terminal device; a number of receiving antennas and/or transmitting antennas supported by the second terminal device, a bandwidth supported by the second terminal device, a frequency band supported by the second terminal device, or a reduced capability terminal type of the second terminal device.

Taking a case where the terminal information includes the reduced capability terminal type of the second terminal device as an example, the terminal information may indicate that the second terminal device is a high-end reduced capability device or a low-end reduced capability device. Taking a case where the terminal information includes the frequency band supported by the second terminal device as an example, the terminal information may indicate that the second terminal device is a FR1 frequency band terminal device or a FR2 frequency band terminal device. Taking a case where the terminal information includes the number of receiving antennas and/or transmitting antennas supported by the second terminal device as an example, the terminal information may indicate the number of receiving antennas and/or transmitting antennas supported by the second terminal device. Taking a case where the terminal information includes the bandwidth supported by the second terminal device as an example, the terminal information may indicate the maximum bandwidth of the second terminal device.

It is to be noted that the terminal information may also be related to other information. For example, the other information may include one or more pieces of the following information: a number of MIMO layers, a modulation order (e.g., the highest modulation order), a duplex mode, a processing time, a number of DRBs (e.g., the maximum number of DRBs that are mandatory to support). That is, the second indication information may indicate the situations of the above other information of the second terminal device, so as to achieve the access control between the first terminal device and the second terminal device.

Similar to the first indication information indicating the connection information, the second indication information may explicitly indicate the terminal information, and/or the second indication information may implicitly indicate the terminal information.

In some embodiment, if the second indication information explicitly indicates the terminal information, the second indication information may include the terminal information. That is, the second terminal device may directly transmit the value of the terminal information to the first terminal device through the second indication information. For example, the second indication information may be included in one or more of the following signaling or channels: a discovery message, a PC5-S message, a PC5-RRC message, a MAC CE or an PSCCH.

In some embodiments, the second indication information may include a second parameter. The second parameter may be associated with the terminal information. In other words, different terminal information may correspond to different second parameters. In other words, different terminal information may be distinguished by the second parameter. As an implementation, different second parameters may be reserved for different terminal information, so as to distinguish different access control modes.

The second parameter may be related to the second terminal device, or the second parameter may include an existing attribute or identifier of the second terminal device. As an implementation, for example, the second parameter may be one or more of the following: a layer 2 ID, a relay service code (RSC), a service identifier (ID), or a physical layer parameter. For example, the physical layer parameter may include at least one of: a RS sequence or a RS cyclic shift.

In some embodiments, after the second terminal device receives the second indication information, the second terminal device may transmit reply information. The reply information may correspond to the second indication information.

The present disclosure does not limit the content of the reply information. For example, the reply information may include the first indication information. Therefore, the above-described content related to the first indication information may be used to explain the reply information. For another example, the reply information may include whether to reject a request corresponding to the second indication information. The request corresponding to the second indication information may be a request message carrying the second indication information. Taking the second indication information carried in a DCR as an example, the reply information may include whether to reject the request of the DCR. Taking the second indication information carried in a discovery solicitation message as an example, the reply information may include whether to reject the discovery request. In some implementations, the first terminal device may determine the content of the reply information according to the second indication information.

In some implementations, the first terminal device may determine whether to transmit the reply information according to the second indication information. Optionally, for a relay scenario, the first terminal device may determine whether to forward the reply information according to the second indication information.

The present disclosure does not limit the type of the message that carries the second indication information. For example, the second indication information may be carried in a discovery solicitation message. Correspondingly, the reply information may be carried in a discovery response message. Alternatively, the second indication information may be carried in a DCR. Correspondingly, the reply information may be carried in an SMC and/or a DCA.

After receiving the reply information, the second terminal device may determine whether to establish a connection with the first terminal device. Alternatively, the second terminal device may determine whether to establish a connection with the first terminal device according to whether the reply information is received.

In some embodiments, the operation of determining whether to establish the connection with the first terminal device may include: determining whether to transmit a connection establishment request to the first terminal device. The connection establishment request may include, for example, the DCR.

In some embodiments, the operation of determining whether to establish the connection with the first terminal device may include: determining whether to continue a process of establishing the connection. Taking a case where the second indication information is carried in the DCR and the reply information is carried in the SMC/DCA as an example, the second terminal device may determine whether to respond to the SMC/DCA, to continue to transmit the information or message for establishing the connection.

It is to be noted that the access control process may multiplex the communication process related to the sidelink in the related technology to reduce signaling interaction. For example, the access control process may multiplex the discovery process or the connection establishment process.

Taking the access control process multiplexing the discovery process as an example, the first indication information or the second indication information may be carried in the discovery message. That is, the first indication information or the second indication information may be transmitted through the discovery message. The discovery message may be any message exchanged between the terminal devices during the discovery process. The discovery message may be, for example, a message involved in model A or model B. Taking mode A as an example, the first indication information may be carried in a discovery announcement message. Taking mode B as an example, the first indication information may be carried in the discovery response message, and the second indication information may be carried in the discovery solicitation message.

Taking the access control process multiplexing the connection establishment process as an example, the first indication information or the second indication information may be carried in a connection establishment message. That is, the first indication information or the second indication information may be transmitted through the connection establishment message. The connection establishment message may be any message exchanged between the terminal devices during the connection establishment process. For example, the first indication information may be carried in the SMC or the DCA. The second indication information may be carried in the DCR.

It is to be noted that the above first terminal device is a terminal device that is expected to control a device with which a connection is established. That is, the first terminal device may be a device that performs access control. For example, the first terminal device may satisfy one of the following conditions: the first terminal device is a non-relay terminal device; the first terminal device is a relay terminal between a terminal device and a network device; or the first terminal device is a relay terminal between a terminal device and a terminal device. In a case where the first terminal device is the relay terminal device, the second terminal device may be a remote terminal device that the first terminal device is expected to control.

The methods provided by the embodiments of the present disclosure are described in detail below through Embodiments I to III.

### Embodiment I

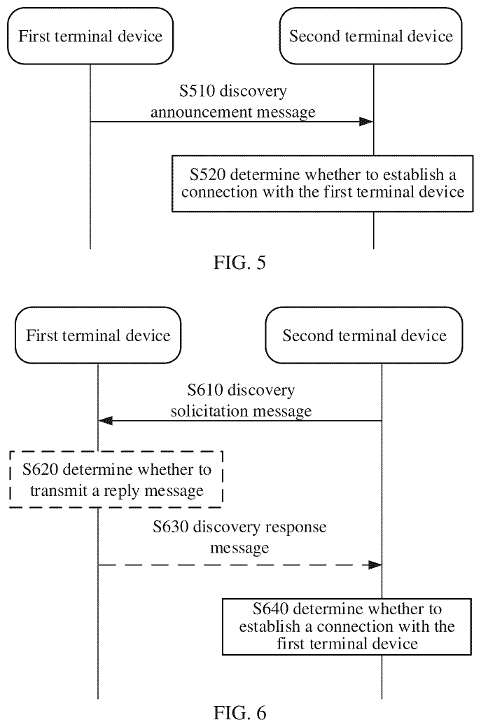

FIG. 5 is a schematic flowchart of a communication method provided in Embodiment 1. The method illustrated in FIG. 5 may be implemented by a first terminal device and a second terminal device. In Embodiment I, access control is implemented in a discovery scenario of mode A.

The method illustrated in FIG. 5 may include steps S510 and S520.

In step S510: the first terminal device transmits a discovery announcement message to the second terminal device.

The discovery announcement message may be used to indicate first indication information. The first indication information is used to indicate connection information.

Optionally, the connection information may include: an indication of whether a first-type terminal device and/or a second-type terminal device can be connected or accessed.

Optionally, the connection information may include: an indication of whether terminal devices of different reduced capability terminal types can be connected or accessed, for example, an indication of whether a terminal device of a high-end reduced capability terminal type or a low-end reduced capability terminal type may be connected or accessed; for another example, an indication of whether a reduced capability device in a FR1 band or a reduced capability device in a FR2 band can be connected or accessed.

Optionally, the connection information may include: an indication of whether terminal devices in different scenarios can be connected or accessed, for example, an indication of whether terminal devices in scenarios such as industrial wireless sensors, video surveillance devices and wearable devices can be connected or accessed.

Optionally, the connection information may include: an indication indicating whether a connection or access is capable for a terminal device with a certain number of receiving antennas and/or transmitting antennas.

Optionally, the connection information may include: an indication indicating whether a connection or access is capable for a terminal device with the maximum bandwidth.

The connection information may be indicated in an explicit indication manner or an implicit indication manner.

In a case where the connection information is indicated by the explicit indication manner, the first indication information may explicitly indicate the connection information through one or more of: a discovery message, a PC5-S message, a PC5-RRC message, a MAC CE or a PSCCH.

In a case where the connection information is indicated by the implicit indication manner, the first indication information may be indicated by a first parameter of a first terminal device itself. For example, the first parameter may include one or more of the following: a layer 2 ID, a RSC, a service ID or a physical layer parameter. For example, different layer 2 IDs may be reserved for different access control modes, that is, different access control modes may be distinguished by layer 2 IDs. For example, different RSCs or service IDs may be reserved for different access control modes, that is, different access control modes may be distinguished by RSCs or service IDs. For example, different physical layer parameters may be reserved for different access control modes, that is, different access control modes may be distinguished by physical layer parameters. For example, the physical layer parameter may include a RS sequence and/or a RS cyclic shift.

In step S520: the second terminal device determines whether to establish a connection with the first terminal device. For example, the second terminal device may determine whether to transmit a connection establishment request to the first terminal device. The connection establishment request may include, for example, a DCR message.

### Embodiment II

FIG. 6 is a schematic flowchart of a communication method provided in Embodiment II. The method illustrated in FIG. 6 may be implemented by a first terminal device and a second terminal device. In Embodiment II, access control is implemented in a discovery scenario of mode B.

The method illustrated in FIG. 6 may include steps S610 and S640.

In step S610: the second terminal device transmits a discovery solicitation message to the first terminal device.

In some embodiments, the method illustrated in FIG. 6 may further include step S620. In step S620: the first terminal device determines whether to transmit a reply message. The reply information may be included in a discovery response message.

In some embodiments, the discovery solicitation message may be used to indicate terminal information. The first terminal device may determine whether to reply to the discovery response message based on the terminal information. The discovery response message may include the reply information. Optionally, for a relay scenario, the second terminal device may determine whether to further forward the discovery response message based on the terminal information. In a case where the first terminal device determines to reply to the discovery response message, the method illustrated in FIG. 6 may include step S630.

In some embodiments, the method illustrated in FIG. 6 may include step S630. In step S630: the first terminal device transmits the discovery response message.

In some embodiments, the discovery solicitation message may be used to indicate the terminal information. The first terminal device may determine the reply information according to the terminal information, and the reply information may be included in the discovery response message. For example, the reply information may indicate whether to reject the request of the second terminal device.

In some embodiments, the discovery solicitation message may not include the terminal information. The first terminal device may transmit the discovery response message, and the discovery response message may be used to indicate the first indication information. The first indication information may be used to indicate the connection information.

Optionally, the terminal information may include an indication of the second terminal device being a first-type terminal device or a second-type terminal device.

Optionally, the terminal information may include an indication of a reduced capability terminal type of the second terminal device. For example, the terminal information may include an indication of the second terminal device being a high-end reduced capability device or a low-end reduced capability device. Alternatively, the terminal information may include an indication of the second terminal device being in a FR1 frequency band or a FR2 frequency band.

Optionally, the terminal information may include an indication of a scenario in which the second terminal device is located. For example, the scenario in which the second terminal is located may include one or more of: industrial wireless sensors, video surveillance devices, or wearable devices.

Optionally, the terminal information may include an indication of the number of receiving antennas and/or transmitting antennas supported by the second terminal device.

Optionally, the terminal information may include an indication of the maximum bandwidth of the second terminal device.

Optionally, the connection information may include: an indication of whether a first-type terminal device and/or a second-type terminal device can be connected or accessed.

Optionally, the connection information may include: an indication of whether terminal devices of different reduced capability terminal types can be connected or accessed, for example, an indication of whether a terminal device of a high-end reduced capability terminal type or a low-end reduced capability terminal type can be connected or accessed; for another example, an indication of whether a reduced capability device in a FR1 band or a reduced capability device in a FR2 band can be connected or accessed.

Optionally, the connection information may include: an indication of whether terminal devices in different scenarios can be connected or accessed, for example, an indication of whether terminal devices in scenarios such as industrial wireless sensors, video surveillance device and wearable devices can be connected or accessed.

Optionally, the connection information may include: an indication indicating whether a connection or access is capable for a terminal device with a certain number of receiving antennas and/or transmitting antennas.

Optionally, the connection information may include: an indication indicating whether an access or connection is capable for a terminal device with the maximum bandwidth.

The terminal information and/or the connection information may be indicated in an explicit indication manner or an implicit indication manner.

In a case where the connection information and/or the terminal information are indicated by the explicit indication manner, the first indication information or the second indication information may explicitly indicate the connection information through one or more of: a discovery message, a PC5-S message, a PC5-RRC message, a MAC CE or a PSCCH.

In a case where the terminal information and/or the connection information are indicated by the implicit indication manner, the first indication information may be indicated by a first parameter of a first terminal device itself, and the second indication information may be indicated by a second parameter of a second terminal device itself. For example, the first parameter or the second parameter may include one or more of the following: a layer 2 ID, a RSC, a service ID or a physical layer parameter. For example, different layer 2 IDs may be reserved for different access control modes, that is, different access control modes may be distinguished by layer 2 IDs. For example, different RSCs or service IDs may be reserved for different access control modes, that is, different access control modes may be distinguished by RSCs or service IDs. For example, different physical layer parameters may be reserved for different access control modes, that is, different access control modes may be distinguished by physical layer parameters. For example, the physical layer parameter may include a RS sequence and/or a RS cyclic shift.

In step S640: the second terminal device determines whether to establish a connection with the first terminal device. For example, the second terminal device may determine whether to transmit a connection establishment request to the first terminal device. The connection establishment request may include, for example, a DCR message.

### Embodiment III

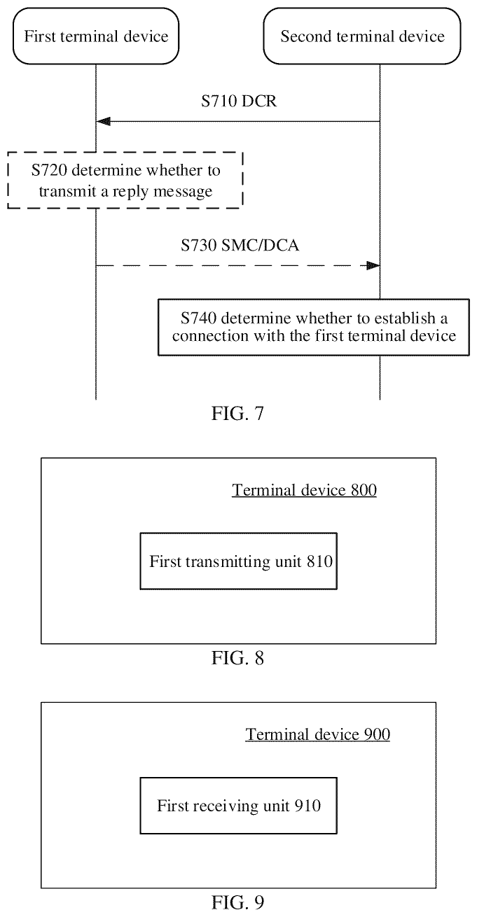

FIG. 7 is a schematic flowchart of a communication method provided in Embodiment III. The method illustrated in FIG. 7 may be implemented by a first terminal device and a second terminal device. In Embodiment III, access control is implemented in a non discovery scenario or an integrated discovery scenario.

The method illustrated in FIG. 7 may include steps S710 and S740.

In step S710: the second terminal device transmits a DCR message to the first terminal device.

In some embodiments, the method illustrated in FIG. 7 may further include step S720. In step S720: the first terminal device determines whether to transmit a reply message. The reply message may be included in an SMC or a DCA.

In some embodiments, the DCR message may be used to indicate terminal information. The first terminal device may determine whether to reply SMC or DCA according to the terminal information. The SMC or the DCA may include the reply information. Optionally, for a relay scenario, the second terminal device may determine whether to further forward the SMC or the DCA according to the terminal information. In a case where the first terminal device determines to reply to the SMC or the DCA, the method illustrated in FIG. 7 may include step S730.

In some embodiments, the method illustrated in FIG. 7 may include step S730. In step S730: the first terminal device transmits the SMC or the DCA.

In some embodiments, the DCR message may be used to indicate the terminal information. The first terminal device may determine the reply information according to the terminal information. For example, the reply information may indicate whether to reject the request of the second terminal device.

In some embodiments, the DCR message may not include the terminal information. The first terminal device may transmit the SMC or the DCA, and the SMC or the DCA may be used to indicate the first indication information. The first indication information may be used to indicate the connection information.

Optionally, the terminal information may include an indication of the second terminal device being a first-type terminal device or a second-type terminal device.

Optionally, the terminal information may include an indication of a reduced capability terminal type of the second terminal device. For example, the terminal information may include an indication of the second terminal device being a high-end reduced capability device or a low-end reduced capability device. Alternatively, the terminal information may include an indication of the second terminal device being in a FR1 frequency band or a FR2 frequency band.

Optionally, the terminal information may include an indication of a scenario in which the second terminal device is located. For example, the scenario in which the second terminal is located may include one or more of: industrial wireless sensors, video surveillance devices, or wearable devices.

Optionally, the terminal information may include an indication of the number of receiving antennas and/or transmitting antennas supported by the second terminal device.

Optionally, the terminal information may include an indication of the maximum bandwidth of the second terminal device.

Optionally, the connection information may include: an indication of whether a first-type terminal device and/or a second-type terminal device can be connected or accessed.

Optionally, the connection information may include: an indication of whether terminal devices of different reduced capability terminal types can be connected or accessed, for example, an indication of whether a terminal device of a high-end reduced capability terminal type or a low-end reduced capability terminal type can be connected or accessed; for another example, an indication of whether a reduced capability device in a FR1 band or a reduced capability device in a FR2 band can be connected or accessed.

Optionally, the connection information may include: an indication of whether terminal devices in different scenarios can be connected or accessed, for example, an indication of whether terminal devices in scenarios such as industrial wireless sensors, video surveillance devices and wearable devices can be connected or accessed.

Optionally, the connection information may include: an indication indicating whether a connection or access is capable for a terminal device with a certain number of receiving antennas and/or transmitting antennas.

Optionally, the connection information may include: an indication indicating whether an access or connection is capable for a terminal device with the maximum bandwidth.

The terminal information and/or the connection information may be indicated in an explicit indication manner or an implicit indication manner.

In a case where the connection information and/or the terminal information are indicated by the explicit indication manner, the first indication information or the second indication information may explicitly indicate the connection information through one or more of: a discovery message, a PC5-S message, a PC5-RRC message, a MAC CE or a PSCCH.

In a case where the terminal information and/or the connection information are indicated by the implicit indication manner, the first indication information may be indicated by a first parameter of a first terminal device itself, and the second indication information may be indicated by a second parameter of a second terminal device itself. For example, the first parameter or the second parameter may include one or more of the following: a layer 2 ID, a RSC, a service ID or a physical layer parameter. For example, different layer 2 IDs may be reserved for different access control modes, that is, different access control modes may be distinguished by layer 2 IDs. For example, different RSCs or service IDs may be reserved for different access control modes, that is, different access control modes may be distinguished by RSCs or service IDs. For example, different physical layer parameters may be reserved for different access control modes, that is, different access control modes may be distinguished by physical layer parameters. For example, the physical layer parameter may include a RS sequence and/or a RS cyclic shift.

In step S740: the second terminal device determines whether to establish a connection with the first terminal device. For example, the second terminal device may determine to continue transmitting a message related to the connection establishment process to the first terminal device, so as to determine whether to complete the connection establishment process.

The method embodiments of the present disclosure are described in detail above, and the device embodiments of the present disclosure are described in detail below. It is to be understood that the description of the method embodiments corresponds to the description of the device embodiments, and therefore, the parts not described in detail may be referred to the preceding method embodiments.

FIG. 8 is a schematic structural diagram of a terminal device 800 provided in an embodiment of the present disclosure. The terminal device 800 may be a first terminal device. The terminal device 800 may include a first transmitting unit 810.

The first transmitting unit 810 is configured to transmit first indication information; where the first indication information is used to indicate connection information, and the connection information includes: whether a first-type terminal device and/or a second-type terminal device are capable of establishing a connection with the first terminal device.

In some embodiments, the first-type terminal device is a reduced capability terminal device, and the second-type terminal device is a non-reduced capability terminal device.

In some embodiments, the connection information further includes one or more pieces of following information: whether a terminal device under a first scenario is capable of establishing a connection with the first terminal device; whether a terminal device supporting a first number of receiving antennas is capable of establishing a connection with the first terminal device; whether a terminal device supporting a first number of transmitting antennas is capable of establishing a connection with the first terminal device; or whether a terminal device supporting a first bandwidth is capable of establishing a connection with the first terminal device.

In some embodiments, the first indication information includes the connection information.

In some embodiments, the first indication information is included in one or more of: a discovery message, a PC5-S message, a PC5-RRC message, a MAC CE, or a PSCCH.

In some embodiments, the first indication information includes a first parameter, and the first parameter is associated with the connection information.

In some embodiments, the first parameter is one or more of: a layer 2 ID, a RSC, a service identifier, or a physical layer parameter.

In some embodiments, the terminal device is further configured to: receive a first request; where transmitting the first indication information includes: transmitting the first indication information in response to receiving the first request.

In some embodiments, the first request is carried in a discovery solicitation message, and the first indication information is carried in a discovery response message.

In some embodiments, the first request is carried in a DCR, and the first indication information is carried in an SMC or a DCA message.

In some embodiments, the first indication information is carried in a discovery message.

In some embodiments, the discovery message includes a discovery announcement message.

FIG. 9 is a schematic structural diagram of a terminal device 900 provided in an embodiment of the present disclosure. The terminal device 900 may be a second terminal device. The terminal device 900 may include a first receiving unit 910.

The first receiving unit is configured to receive first indication information transmitted by a first terminal device; where the first indication information is used to indicate connection information, and the connection information includes: whether a first-type terminal device and/or a second-type terminal device are capable of establishing a connection with the first terminal device.

In some embodiments, the first-type terminal device is a reduced capability terminal device, and the second-type terminal device is a non-reduced capability terminal device.

In some embodiments, the connection information further includes one or more pieces of following information: whether a terminal device under a first scenario is capable of establishing a connection with the first terminal device; whether a terminal device supporting a first number of receiving antennas is capable of establishing a connection with the first terminal device; whether a terminal device supporting a first number of transmitting antennas is capable of establishing a connection with the first terminal device; or whether a terminal device supporting a first bandwidth is capable of establishing a connection with the first terminal device.

In some embodiments, the first indication information includes the connection information.

In some embodiments, the first indication information is included in one or more of: a discovery message, a PC5-S message, a PC5-RRC message, a MAC CE, or a PSCCH.

In some embodiments, the first indication information includes a first parameter, and the first parameter is associated with the connection information.

In some embodiments, the first parameter is one or more of: a layer 2 ID, a RSC, a service identifier, or a physical layer parameter.

In some embodiments, the terminal device is further configured to: transmit a first request; where transmission of the first indication information is responsive to reception of the first request.

In some embodiments, the first request is carried in a discovery solicitation message, and the first indication information is carried in a discovery response message.

In some embodiments, the first request is carried in a DCR, and the first indication information is carried in an SMC or a DCA message.

In some embodiments, the first indication information is carried in a discovery message.

In some embodiments, the discovery message includes a discovery announcement message.

In some embodiments, the terminal device is further configured to: determine whether to establish a connection with the first terminal device according to the first indication information.

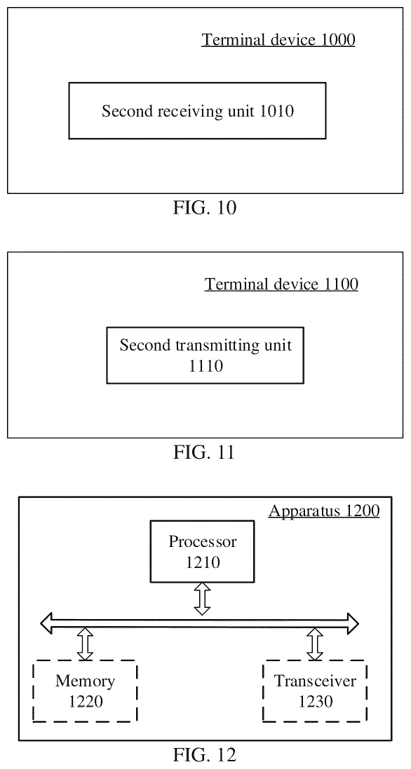

FIG. 10 is a schematic structural diagram of a terminal device 1000 provided in an embodiment of the present disclosure. The terminal device 1000 may be a first terminal device. The terminal device 1000 may include a second receiving unit 1010.

The second receiving unit 1010 is configured to receive second indication information transmitted by a second terminal device; where the second indication information is used to indicate terminal information, and the terminal information includes: the second terminal device being a first-type terminal device or a second-type terminal device.

In some embodiments, the first-type terminal device is a reduced capability terminal device, and the second-type terminal device is a non-reduced capability terminal device.

In some embodiments, the terminal information further includes one or more pieces of following information: a scenario of the second terminal device; a number of receiving antennas and/or transmitting antennas supported by the second terminal device; or a bandwidth supported by the second terminal device.

In some embodiments, the terminal device is further configured to: transmit reply information corresponding to the second indication information in response to receiving the second indication information.

In some embodiments, the terminal device is further configured to: determine whether to transmit the reply information according to the second indication information; where transmitting the reply information corresponding to the second indication information includes: transmitting the reply information in a case of determining to transmit the reply information.

In some embodiments, content of the reply information is determined based on the second indication information.

In some embodiments, the second indication information includes the terminal information.

In some embodiments, the second indication information is included in one or more of: a discovery message, a PC5-S message, a PC5-RRC message, a MAC CE, or a PSCCH.

In some embodiments, the second indication information includes a second parameter, and the second parameter is associated with the terminal information.

In some embodiments, the second parameter is one or more of: a layer 2 ID, a RSC, a service identifier, or a physical layer parameter.

In some embodiments, the second indication information is carried in a discovery solicitation message, and the reply information is carried in a discovery response message.

In some embodiments, the second indication information is carried in a DCR, and the reply information is carried in an SMC or a DCA message.

FIG. 11 is a schematic structural diagram of a terminal device 1100 provided in an embodiment of the present disclosure. The terminal device 1100 may be a second terminal device. The terminal device 1100 may include a second transmitting unit 1110.

The second transmitting unit 1110 is configured to transmit second indication information to a first terminal device; where the second indication information is used to indicate terminal information, and the terminal information includes: the second terminal device being a first-type terminal device or a second-type terminal device.

In some embodiments, the first-type terminal device is a reduced capability terminal device, and the second-type terminal device is a non-reduced capability terminal device.

In some embodiments, the terminal information further includes one or more pieces of following information: a scenario of the second terminal device; a number of receiving antennas and/or transmitting antennas supported by the second terminal device; or a bandwidth supported by the second terminal device.

In some embodiments, the terminal device is further configured to: receive reply information corresponding to the second indication information.

In some embodiments, the terminal device is further configured to: determine whether to establish a connection with the first terminal device according to the reply information.

In some embodiments, the terminal device is further configured to: determine whether to establish a connection with the first terminal device according to whether reply information corresponding to the second indication information is received.

In some embodiments, content of the reply information is determined based on the second indication information.

In some embodiments, the second indication information includes the terminal information.

In some embodiments, the second indication information is included in one or more of: a discovery message, a PC5-S message, a PC5-RRC message, a MAC CE, or a PSCCH.

In some embodiments, the second indication information includes a second parameter, and the second parameter is associated with the terminal information.

In some embodiments, the second parameter is one or more of: a layer 2 ID, a RSC, a service identifier, or a physical layer parameter.

In some embodiments, the second indication information is carried in a discovery solicitation message, and the reply information is carried in a discovery response message.

In some embodiments, the second indication information is carried in a DCR, and the reply information is carried in an SMC or a DCA message.

In an optional embodiment, the first transmitting unit 810, the first receiving unit 910, the second receiving unit 1010 or the second transmitting unit 1110 may be a transceiver 1230. As illustrated in FIG. 12, the terminal device 800, the terminal device 900, the terminal device 1000 and the terminal device 1100 may further include a processor 1810 and a memory 1220.

FIG. 12 is a schematic structural diagram of an apparatus for communication according to an embodiment of the present disclosure. The dashed lines in FIG. 12 indicate that units or modules are optional. The apparatus 1200 may be used to implement the methods described in the above method embodiments. The apparatus 1200 may be a chip, a terminal device or a network device.

The apparatus 1200 may include one or more processors 1210. The processor 1210 may support the apparatus 1200 to implement the methods described in the above method embodiments. The processor 1210 may be a general-purpose processor or a special-purpose processor. For example, the processor may be a central processing unit (CPU). Alternatively, the processor may be other general-purpose processors, a digital signal processor (DSP), an application specific integrated circuit (ASIC), a field programmable gate array (FPGA) or other programmable logic devices, a discrete gate, a transistor logic device, a discrete hardware component or the like. The general-purpose processor may be a microprocessor, or the processor may be any conventional processor or the like.

The apparatus 1200 may further include one or more memories 1220. The memory 1220 having a program stored thereon, and the program may be executed by the processor 1210, to enable the processor 1210 to perform the methods described in the above method embodiments. The memory 1220 may be independent of the processor 1210 or may be integrated into the processor 1210.

The apparatus 1200 may further include a transceiver 1230. The processor 1210 may communicate with other devices or chips through the transceiver 1230. For example, the processor 1210 may transmit and receive data with other devices or chips through the transceiver 1230.

The embodiments of the present disclosure further provide a non-transitory computer-readable storage medium for storing a program. The non-transitory computer-readable storage medium may be applied to a terminal or network device provided in the embodiments of the present disclosure, and the program enables a computer to perform the methods performed by the terminal or network device in various embodiments of the present disclosure.

The embodiments of the present disclosure further provide a computer program product. The computer program product includes a program. The computer program product may be applied to a terminal or network device provided in the embodiments of the present disclosure, and the program enables a computer to perform the methods performed by the terminal or network device in various embodiments of the present disclosure.

The embodiments of the present disclosure further provide a computer program. The computer program may be applied to a terminal or network device provided in the embodiments of the present disclosure, and the computer program enables a computer to perform the methods performed by the terminal or network device in various embodiments of the present disclosure.

It is to be understood that the terms “system” and “network” may be used interchangeably in the present disclosure. In addition, terms used in the present disclosure are only used to explain embodiments of the present disclosure and are not intended to limit the present disclosure. The terms “first”, “second”, “third”, “fourth” or the like in the specification, claims and the drawings are used to distinguish different objects and are not used to describe a specified sequence. In addition, the terms “include”, “comprise” and “have” and any variations thereof are intended to cover non-exclusive inclusion.

In the embodiments of the present disclosure, “indicate” mentioned in the embodiments of the present disclosure may mean a direct indication or an indirect indication, or represent that there is an association relationship. For example, A indicates B, which may mean that A directly indicates B, for example, B may be obtained through A; or it may mean that A indirectly indicates B, for example, A indicates C, and B may be obtained through C; or it may mean that there is an association relationship between A and B.

In the embodiment of the present disclosure, “B corresponding to A” means that B is associated with A, and B may be determined based on A. However, it is also to be understood that determining B based on A does not mean that B is determined based on A alone; and B may also be determined based on A and/or other information.

In the embodiments of the present disclosure, the term “correspond” may mean that there is a direct correspondence or indirect correspondence between the two, or it may mean that there is an associated relationship between the two, or it may mean a relationship of indicating and being indicated, configuring and being configured, or the like.

In the embodiment of the present disclosure, “predefined” or “preconfigured” may be achieved by pre-storing corresponding codes, forms or other means used for indicating relevant information in devices (e.g., including a terminal device and network device), and the present disclosure is not limited to the implementation thereof. For example, predefined may refer to what is defined in a protocol.

In the embodiments of the present disclosure, the “protocol” may refer to a standard protocol in the field of communication, and may include, for example, LTE protocol, NR protocol, or related protocols applied in future communication systems, which are not limited in the present disclosure.

In the embodiments of the present disclosure, the term “and/or” is only an association relationship to describe associated objects, meaning that there may be three relationships between associated objects, for example, “A and/or B” may represent: A exists alone, both A and B exist, and B exists alone. In addition, a character “/” herein generally means that related objects before and after this character are in an “or” relationship.

In the embodiments of the present disclosure, the “comprising/including” may refer to direct including or indirect including. Optionally, the term “comprising/including” mentioned in the embodiments of the present disclosure may be replaced with “indicating” or “for determining”. For example, A including B may be replaced by A indicating B, or A being used to determine B.

In various embodiments of the present disclosure, the magnitude of the serial numbers of above processes does not mean the order of execution. The order of execution of each process should be determined by its function and internal logic, and should not constitute any limitation on the implementation process of the embodiments of the present disclosure.

In the several embodiments provided in the present disclosure, it is to be understood that the disclosed systems, devices and methods may be implemented in other ways. For example, the apparatus embodiments described above are merely illustrative. For example, the division of the units is merely a logical function division. There may be other division ways in the actual implementation. For example, multiple units or components may be combined or integrated into another system, or some features may be ignored or not implemented. Another point is that the mutual coupling or direct coupling or communication connection illustrated or discussed may be indirect coupling or communication connection through some interface, apparatus or units, and may be electrical, mechanical or other forms.

The units described as separation parts may or may not be physically separated, and the component displayed as a unit may be or may not be a physical unit, that is, it may be located at one place, or it may be distributed to multiple network units. Some or all of the units may be selected according to actual requirements to achieve the purpose of the schemes of the embodiments.

In addition, various functional units in various embodiments of the present disclosure may be integrated into one processing unit, various units may exist physically alone, or two or more units may be integrated into one unit.

In the above embodiments, all or part of them may be implemented by software, hardware, firmware or any combinations thereof. When implemented by the software, all or part of them may be implemented in the form of a computer program product. The computer program product includes one or more computer instructions. When the computer program instructions are loaded and executed on a computer, the processes or functions described in the embodiments of the present disclosure are generated in whole or in part. The computer may be a general-purpose computer, a special-purpose computer, a computer network, or other programmable devices. The computer instructions may be stored in a non-transitory computer-readable storage medium, or transmitted from one non-transitory computer-readable storage medium to another non-transitory computer-readable storage medium. For example, the computer instructions may be transmitted from a website, a computer, a server or a data center to another website, computer, server, or data center via wired (e.g., a coaxial cable, optical fiber, digital subscriber line (DSL)) or wireless (e.g., infrared, wireless, microwave) means. The non-transitory computer-readable storage medium may be any available medium that may be read by the computer or a data storage device such as a server or a data center that includes one or more available media. The available media may be magnetic media (e.g., a floppy disk, a hard disk or a magnetic tape), optical media (e.g., a digital video disc (DVD)), or semiconductor media (e.g., a solid state disk (SSD)).

The foregoing descriptions are merely implementations of the present disclosure, but the protection scope of the present disclosure is not limited thereto. Variations or replacements that any person skilled in the art could readily conceive of within the technical scope disclosed in the present disclosure shall fall within the protection scope of the present disclosure. Therefore, the protection scope of the present disclosure shall be subject to the protection scope of the claims.

What is claimed is:

1. A communication method, comprising:
transmitting, by a first terminal device, first indication information;
wherein the first indication information is used to indicate connection information, and the connection information comprises: whether a first-type terminal device and/or a second-type terminal device are capable of establishing a connection with the first terminal device.

2. The method according to claim 1, wherein the first-type terminal device is a reduced capability terminal device, and the second-type terminal device is a non-reduced capability terminal device.

3. The method according to claim 1, wherein the connection information further comprises one or more pieces of following information:
whether a terminal device under a first scenario is capable of establishing a connection with the first terminal device;
whether a terminal device supporting a first number of receiving antennas is capable of establishing a connection with the first terminal device;
whether a terminal device supporting a first number of transmitting antennas is capable of establishing a connection with the first terminal device; or
whether a terminal device supporting a first bandwidth is capable of establishing a connection with the first terminal device.

4. The method according to claim 1, wherein the first indication information comprises the connection information, wherein
the first indication information is comprised in one or more of: a PC5-signaling (PC5-S) message, a PC5-radio resource control (PC5-RRC) message, a media access control control element (MAC CE), or a physical sidelink control channel (PSCCH).

5. The method according to claim 1, wherein the first indication information comprises a first parameter, and the first parameter is associated with the connection information, wherein
the first parameter is one or more of: a layer 2 identifier (ID), a relay service code (RSC), a service identifier, or a physical layer parameter.

6. The method according to claim 1, further comprising:
receiving, by the first terminal device, a first request;
wherein transmitting, by the first terminal device, the first indication information comprises:
in response to receiving the first request, transmitting, by the first terminal device, the first indication information.

7. The method according to claim 6, wherein the first request is carried in a discovery solicitation message, and the first indication information is carried in a discovery response message; or
the first request is carried in a direct communication request (DCR), and the first indication information is carried in a security mode command (SMC) or a direct communication accept (DCA) message.

8. The method according to claim 1, wherein the first indication information is carried in a discovery message, wherein
the discovery message comprises a discovery announcement message.

9. A communication method, comprising:
receiving, by a second terminal device, first indication information transmitted by a first terminal device;
wherein the first indication information is used to indicate connection information, and the connection information comprises: whether a first-type terminal device and/or a second-type terminal device are capable of establishing a connection with the first terminal device.

10. The method according to claim 9, wherein the first-type terminal device is a reduced capability terminal device, and the second-type terminal device is a non-reduced capability terminal device.

11. The method according to claim 9, wherein the connection information further comprises one or more pieces of following information:
whether a terminal device under a first scenario is capable of establishing a connection with the first terminal device;
whether a terminal device supporting a first number of receiving antennas is capable of establishing a connection with the first terminal device;
whether a terminal device supporting a first number of transmitting antennas is capable of establishing a connection with the first terminal device; or
whether a terminal device supporting a first bandwidth is capable of establishing a connection with the first terminal device.

12. The method according to claim 9, wherein the first indication information comprises the connection information, wherein
the first indication information is comprised in one or more of: a PC5-signaling (PC5-S) message, a PC5-radio resource control (PC5-RRC) message, a media access control control element (MAC CE), or a physical sidelink control channel (PSCCH).

13. The method according to claim 9, wherein the first indication information comprises a first parameter, and the first parameter is associated with the connection information, wherein
the first parameter is one or more of: a layer 2 identifier (ID), a relay service code (RSC), a service identifier, or a physical layer parameter.

14. The method according to claim 9, further comprising:
transmitting, by the second terminal device, a first request;
wherein transmission of the first indication information is responsive to reception of the first request.

15. The method according to claim 14, wherein the first request is carried in a discovery solicitation message, and the first indication information is carried in a discovery response message; or
the first request is carried in a direct communication request (DCR), and the first indication information is carried in a security mode command (SMC) or a direct communication accept (DCA) message.

16. The method according to claim 9, wherein the first indication information is carried in a discovery message, wherein
the discovery message comprises a discovery announcement message.

17. The method according to claim 9, further comprising:
determining, by the second terminal device, whether to establish a connection with the first terminal device according to the first indication information.

18. A terminal device, comprising: a memory and a processor; wherein the memory is configured to store a program, and the processor is configured to call the program in the memory, to enable the terminal device to perform:
transmitting first indication information;
wherein the first indication information is used to indicate connection information, and the connection information comprises: whether a first-type terminal device and/or a second-type terminal device are capable of establishing a connection with the terminal device.

19. The terminal device according to claim 18, wherein the first-type terminal device is a reduced capability terminal device, and the second-type terminal device is a non-reduced capability terminal device.

20. A terminal device, comprising: a memory and a processor; wherein the memory is configured to store a program, and the processor is configured to call the program in the memory, to enable the terminal device to perform the method according to claim 9.
